(19) United States
(12) Patent Application Publication
(10) Pub. No.: US 2021/0158339 A1
(43) Pub. Date: May 27, 2021

(54) A METHOD OF FACILITATING TRANSACTIONS BETWEEN USERS

(71) Applicant: Elbaite Holdings Pty Limited, Caulfield, VIC (AU)

(72) Inventors: Mortaza TOLLO, Caulfield, VIC (AU); Karl James GRAF, Melbourne, VIC (AU); Joseph RUSSELL, Melbourne, VIC (AU)

(73) Assignee: Elbaite Holdings Pty Limited, Caulfield, VIC (AU)

(21) Appl. No.: 17/257,144

(22) PCT Filed: Jul. 12, 2019
(86) PCT No.: PCT/AU2019/000084

§ 371 Date: Dec. 30, 2020

(30) Foreign Application Priority Data
Jul. 13, 2018 (AU) 2018902536

(51) Int. Cl. G06Q 20/38; G06Q 20/02; G06Q 40/02; G06Q 20/10; G06Q 20/06; G06Q 20/12; G06Q 20/40; G06Q 50/26; G06Q 30/00

(52) U.S. Cl. CPC G06Q 20/381; G06Q 20/02; G06Q 40/02; G06Q 20/108; G06Q 20/0655; G06Q 20/3829; G06Q 20/3674; G06Q 20/389; G06Q 20/4014; G06Q 50/265; G06Q 30/0185; G06Q 2220/00; G06Q 20/1235

(57) ABSTRACT

Disclosed herein is a method of facilitating transactions between users using a transaction processor, the transaction processor being configured to facilitate at least one transaction between a first and second user, the method comprising: providing a transaction user interface configured to receive currency and identification information from the users; facilitating transfer of at least one currency payment between the first and second users, wherein the at least one currency payment is based on the currency information; verifying the at least one currency payment has been transferred correctly; and indicating to the users that the transfer has been made.

### RELATED APPLICATIONS

This application claims priority to Australian provisional application no. 2018902561 filed 13 Jul. 2018, the entire content of which is incorporated herein by reference.

### FIELD OF THE INVENTION

This invention relates to a method of facilitating transactions between users in particular currency transactions.

### BACKGROUND OF THE INVENTION

Currencies, such as the fiat-currency of a country such as the Euro, US Dollar or Australian Dollar are transferred from one user to another for a variety of reasons, and can be exchanged for goods or services.

Crypto currencies are digital currencies developed to provide payment for goods and services, and are a medium of exchange designed around securely exchanging information and value. Public-private key pairs are used to ensure the security of crypt-currencies. Public and private keys pairs together, separately and individually are used to sign transactions, crypto currencies or other related e commerce transactions in order to unlock value or show ownership of a particular cryptocurrency, transaction or combination thereof

Keys may be simple or complex, and the more complex the key, its management and application, the more secure the use of crypto-currencies. In order to use a crypto-currency for a financial transaction it is typically stored in a digital or offline wallet. Cryptocurrency wallets are associated with addresses with act as a locator to the wallet to allow deposit and withdrawal from the wallet. Private keys are used to access the wallet addresses.

While fiat-currencies are usually exchanged at a bank or established currency exchange using well-established rules, crypto-currency exchanges are based on a digital audit chain used to record transactions commonly known as a blockchain. The crypto-currencies are typically exchanged through web-based trading exchanges which typically allow trading of one type of electronic currency, such as Bitcoin or Ethereum, for another type of currency.

In such systems, prior to making any trades, traders have to transfer their digital currencies from their personal digital wallets or accounts, to digital wallets controlled by an exchange and located on central processing servers. Each exchange acts as an escrow agent for those funds while trades are performed within the system. These large amounts of digital currencies pooled and kept in central locations, attract the attention of hackers and thieves, and as such are, their servers are frequently subject to cyber-attack or internal heist. If these schemes are successful, large amounts of digital currencies can be stolen which force the exchanges to declare bankruptcy and where it is difficult if not futile for traders to recover their funds.

Examples of the invention seek to solve or at least ameliorate one or more disadvantages of previous cryptocurrency exchanges.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to a first aspect of the present invention there is provided a method of facilitating transactions between users using a transaction processor, the transaction processor being configured to facilitate at least one transaction between a first and second user comprising: providing a transaction user interface configured to receive currency and identification information from the users; facilitating transfer of at least one currency payment between the first and second users, wherein the at least one currency payment is based on the currency information; verifying the at least one currency payment has been transferred correctly; and indicating to the users that the transfer has been made.

According to an embodiment, facilitating transfer of at least one currency payment comprises receiving the at least one currency payment in a secure storage location associated with the transaction processor.

According to a second aspect of the present invention there is provided a method of facilitating transactions between users using a transaction processor, the transaction processor being configured to facilitate at least one transaction between a first and second user comprising: providing a transaction user interface configured to receive currency and identification information from users; facilitating transfer of at least one currency payment between the first and second users, wherein the at least one currency payment is based on the currency information; wherein facilitating transfer of the at least one currency payment comprises receiving one of the at least one currency payment in a secure storage location associated with the transaction processor.

According to an embodiment, the method includes verifying the at least one currency payment has been transferred correctly and indicating to the users that the transfer has been made. This method provides the advantage that the transfers are verified correctly and both parties are informed which reduces the possibility of fraudulent behaviour on the part of the users. This obviate the needs for the users to meet in person or to use smart contracts, thereby being a safer and quicker way of conducting transactions involving cryptocurrency.

According to an embodiment, facilitating transfer of the at least one currency payment comprises facilitating a first transfer of a first currency payment from the first user to the second user and facilitating a second transfer of a second currency payment from the second user to the first user. Preferably, the transaction processor facilitates the first transfer before the second transfer.

According to an embodiment, facilitating one of said transfers comprises a transfer of one of said currency payments from the secure storage location when the other of said transfers has been verified.

According to an embodiment, a transfer to the secure storage location comprises a transfer of fiat currency and the secure storage location is a bank account. Preferably, the bank account is associated with the transaction processor and is not associated with one of the users. Use of such a secure storage location provides the advantage of being less susceptible to fraud or hacking and which can be easily monitored for transaction activity by the transaction processor. Furthermore, it is easier to return fiat currency payments to the user if required reducing the risk to buyers of currency, in particular crypto currency. Finally, should any tampering or errors occur in relation to the fiat currency transfer it is easier to track via the secure location and the fiat currency would be also protected by protective measures that are in place for financial institutions.

According to an embodiment, verifying at least one currency payment has been transferred correctly includes constant monitoring of the bank account to determine when the fiat currency has been deposited. Alternatively, the step of verifying the at least one currency payment has been transferred correctly comprises periodic or manual checking of the of the bank account to determine when the fiat currency has been deposited. The step of verifying the at least one currency payment can include checking of the bank account for a unique identifier which has been provided to user for the purpose of identifying the currency payment. The unique identifier can be in the form of a unique combination of alphanumeric characters.

According to an embodiment, at least one currency payment comprises cryptocurrency.

According to an embodiment, facilitating transfer of the cryptocurrency comprises facilitating transfer of information relating to assignment of an access right of the cryptocurrency from one user to another user.

According to an embodiment, information relating to assignment of an access right of a cryptocurrency includes a public address key.

According to an embodiment, verifying the transfer of cryptocurrency comprises determining the access right is possessed by the second user by monitoring information from an audit chain associated with that cryptocurrency. The step of the transaction processor monitoring information from the audit chain in relation to the ownership of the access rights allows verification that the seller has the right and sufficient cryptocurrency to complete the transaction thereby preventing fraudulent behaviour and protecting the buyer.

According to an embodiment, monitoring information from the audit chain comprises constant monitoring of the audit chain to determine when the cryptocurrency has been deposited. Alternatively, monitoring information from the audit chain comprises manual or period checking of the audit chain.

According to an embodiment, the transaction processor is configured to facilitate an exchange of currency between the two users, wherein the first transfer is a fiat currency payment and the second transfer is a cryptocurrency payment in exchange for the fiat currency payment.

According to an embodiment, facilitating transfer of at least one currency payment between users includes generating an offer based on the currency information, the offer being viewable on the transaction user interface and selectable by the second user.

According to an embodiment, receiving identification information from the users includes one or more of the following information:

photo identification including identity documents such as passports, driver's license;

bank account information;

email address information;

telephone number information; and

other contact information.

According to an embodiment, the cryptocurrency comprises one or more of the following: Bitcoin, Bitcoin cash, ripple, Litecoin, Eos, ethereum, or a transferable token based thereon or anything similar that is considered a cryptocurrency. The above method is advantageously applicable to all cryptocurrency and tokens thereof, unlikely many cryptocurrency systems which only allow transfers of a single or a few associated cryptocurrencies and conveniently allows easy transfer from and to fiat currencies for all users.

According to a further aspect of the present invention, there is provided a transaction processor when used to perform the method as described above.

### BRIEF DESCRIPTION OF THE DRAWINGS

The present invention will now be described, by way of non-limiting example, with reference to the accompanying drawings in which:

FIG. 1 is a functional diagram of an exemplary system embodying the present invention; and

FIGS. 2 and 3 are process diagrams illustrating preferred methods of facilitating transactions according to the present invention.

### DETAILED DESCRIPTION OF THE INVENTION

The present invention will be described below in relation to a system and method for facilitating transactions between users across an electronic medium. The system and method is able to register users and to create a profile for each user.

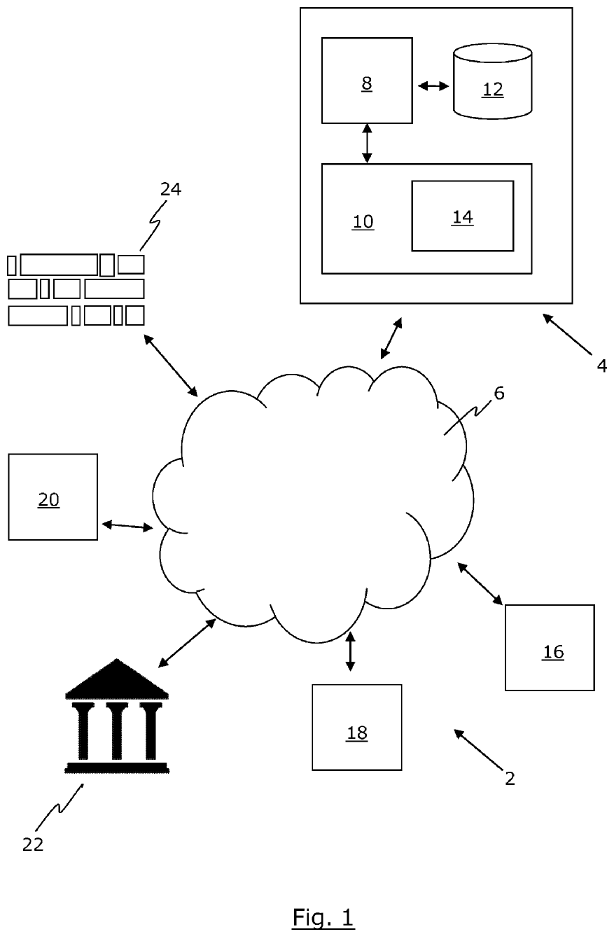

FIG. 1 illustrates a functional diagram of an exemplary system 2 within which the present invention may be embodied. The system 2 comprises a host service 4 (“transaction processor”) which is configured as described in greater detail below, in accordance with a preferred embodiment of the present invention, connected to a plurality of parties 16, 18, 20 over a network 6. The host service 4 is configured to facilitate selective engagement between at least two users 16, 18 who are customers of the transaction processor 4. The two parties 16, 18 may be a business or an individual where the two parties 16, 18 wish to participate in a transaction.

The exemplary host service 4 comprises one or more host servers that are connected to a network 6, and therefore communicate via that network 6 via wired or wireless communication in a conventional manner as will be appreciated by those skilled in the art. The host servers are configured to store a variety of information collected from the users and third parties 16, 18, 20, 22 and 24. This communication enables remote access by the connected parties, and to provide the server 4 with access to other resources, such as financial institutions 22 that can store and exchange fiat currencies, including banks and the like, and to an cryptographically secured audit chain 24 for digitally recording the transactions, such as a blockchain. Access to the blockchain 24 may mean direct access from the processor 4 reading directly from the blockchain 24 or indirect access whereby a further third party (not shown) can facilitate flow of information between the transaction processor 4 and the blockchain 24.

The host service 4 is also connected via the network 6 to other third parties 20 which may facilitate verification of data such as identification information associated with users, for example credit card companies or government databases.

The host servers are also able to house multiple databases 12 necessary for the operation of methods and systems of the present invention. The host servers may comprise any of a number of servers now to those skilled in the art and are intended to be operably connected to the network so as to operable link to a computer system associated with the users 16, 18 or third parties, 20, 22 or 24. The host servers can be operated and supplied by a third party server providing service, or alternatively can be hosted locally by the transaction processor 4.

The host servers typically include a central processing unit or CPU 8 with includes one or more microprocessors and memory 10 operably connected to the CPU. The memory can include any combination of random access memory (RAM), a storage medium such as a magnetic hard disk drives(s) 12 and the like. The storage medium 12 is used for long term storage of program components as well as storage of data relating to the customers and their transactions. The central processing unit 8 which is associated with random access memory 10, is used for containing program instructions and transient data related to the operation of services provided by the host service 4. In particular, the memory 10 contains a body of instructions 14 for implementing at least part of a method for facilitating transactions between users. The instructions 14 also include instructions for providing a web-based user interface which enables users to remote access the currency exchange from any client computer executing conventional web browser software.

In a preferred embodiment, the computing network 6 is the internet or a dedicated mobile or cellular network in combination with the internet, such as a GSM, CDMA, UTMS, WCDMA or LTE networks and the like. Other types of networks such as an intranet, an extranet, a virtual private network (VPN) and non-TCP/IP based networks are also envisaged.

The users 16, 18 may include individual users or business entities such as companies who have email or similar electronic communication accounts. Each of the users 16,18 are registered with the host service 4 via a formal registration process that captures the relevant information required by the present invention, which will be discussed in more detail below.

Each user 16, 18 is able to receive communication from the host service 4 via the network 16 and is able to communicate with the host service 4 via the network 16. Each user 16, 18 may access the network 6 by way of a smartphone, tablet, laptop or personal computer, or any other personal electronic device.

The host service 4 may be provided with a dedicated software application which is run by the CPU stored in the host servers. Once installed, the software application of the host service 4 provides an interface that enables the host service 4 to facilitate communication of transaction information to a predetermined user 16, 18.

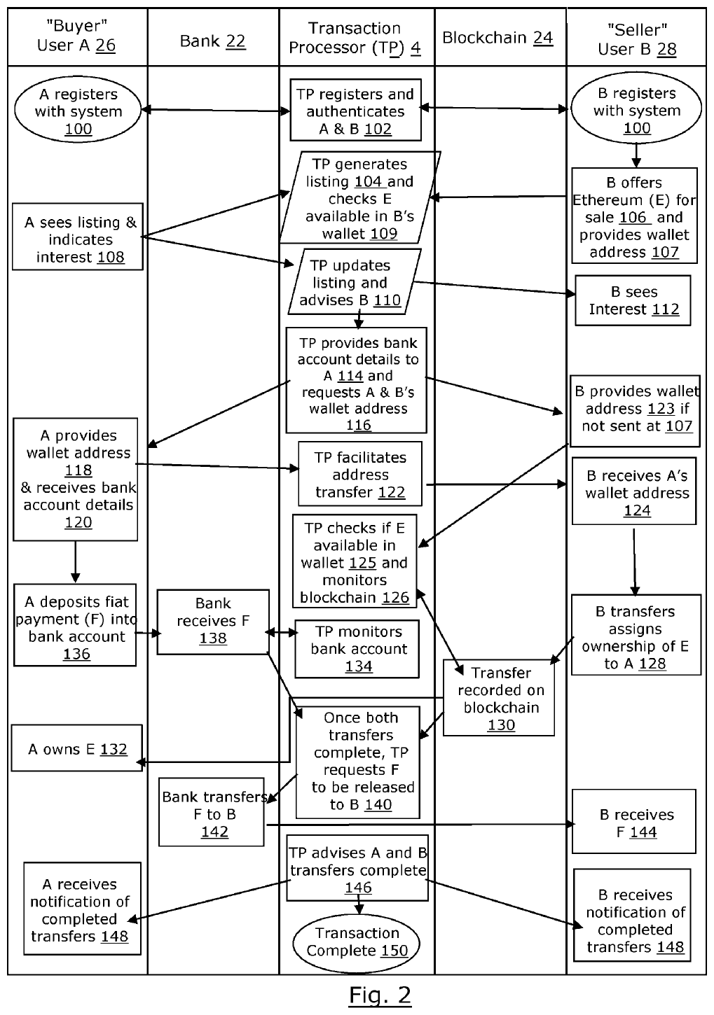

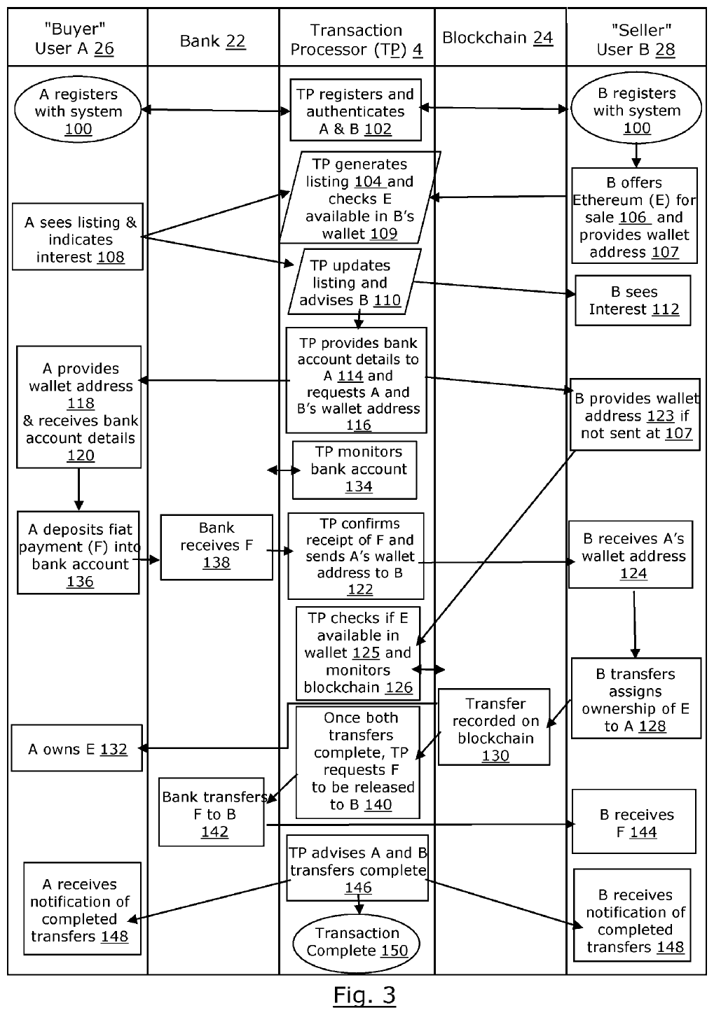

With reference to FIGS. 2 and 3, there are shown process diagrams of exemplary methods of facilitating transactions between users in accordance with preferred embodiments of the present invention. In particular, there is provided a host service, such as a transaction processor 4 which is an entity which coordinates the transaction, such as a company or the like, providing a service to facilitate the transactions between users 16, 18 of the service via the web-based user interface and which also involves other parties involved with the transaction such as financial institutions 22 including banks and access to the audit chain 24 such as a blockchain.

The transaction processor 4 is configured to receive basic identification information such as a user name and password so that each party can be registered as a user 26, 28 100. The process of registering as a user 100 includes creation of an account on the user interface so that users can then enter additional identification information. The additional identification information includes information that verifies the identity of the users A and B 26, 28 which can include names, email addresses, telephone numbers, physical address locations and the like which allow the users to be contacted for verification of identity which may be done by the transaction processor by telephone, email or other contact means. The identification information can include identity documents such as passports, driver's licenses and the like. The identification information can also be verified via third parties such as a credit card company, financial institution, and government body.

The information that identifies the users 26, 28 may be information required to fulfil anti-money laundering, anti-fraud or any other statutory regulations required for compliance in the jurisdiction of the user. This information may include business names, bank account information, credit history information, country of residence, identity documents or other information required to make financial transactions. Once this additional identification information has been verified, the transaction processor 4 registers the users 26, 28 as authenticated members who can have full access to conduct financial transactions via the transaction processor 102. However if the identity of the users have not yet been authenticated, there may be limitations on the transactions they are permitted to do. For instance, the users may be limited to viewing possible transactions listed on the user interface but are not allowed to complete those transactions, or the transactions may be limited to certain destination and source jurisdictions, currencies or a maximum transaction amount.

Once a user has been verified, the transaction processor 4 is configured to receive information from the user which relates to a transaction, for example, a first currency type, which they might wish to sell or buy, and a second currency type they may wish to receive or provide in return respectively. The first and second currency can be a fiat currency as accepted in any jurisdiction, for example, US dollars, Australian dollars, Euro and the like. The first and second currency may be a digital or virtual currency known, used or considered as cryptocurrency such as Bitcoin, Ethereum, Ripple, Eos, Litecoin, and the like or a token associated with a particular blockchain or cryptocurrency, for example an Ethereum token or any other item considered. The first and second currency may be a single currency or a combination of currencies, whether fiat or digital.

The transaction processor 4 is then configured to generate a listing based on that transaction information which is viewable by users on the user interface 104. The listing includes information relating to the first currency type, the first currency amount, and the second currency type and amount which a user wishes to receive in exchange. Alternatively, a user can select at least one currency type and currency amount, and the transaction processor 4 can then recommend a range of currency types, whether fiat or digital, and their associated amounts which can be calculated based on information retrieved from current rates of exchange. The user can then select which currency or currencies they wish to exchange for the currency that they currently own. In an example, the listing can be generated based on an amount of cryptocurrency that a user wishes to sell or buy.

Other users can then select that listing to indicate their interest in purchasing or selling that same currency type and amount. The transaction processor 4 updates the listing to show that there is interest in the offer and informs the seller or buyer of the interest before, after or at the same time the listing is updated 108.

In the examples illustrated in FIGS. 2 and 3, user B 28, i.e. the seller, offers an amount of first currency, i.e. Ethereum (E) for sale 106 for a second currency, i.e an amount of fiat currency (F), this information is used to generate a listing which is viewable by users 26, 28 of the transaction processor 104. At this time, user B may provide their cryptocurrency address information to the transaction processor 4, which can be in the form of a wallet address or public address key 107. The transaction processor 4 can then verify that the amount of cryptocurrency offered for sale is currently owned by the user 109 with that address information, in this example user B. This provides additional security to the transaction(s) as there is more confidence that the exchange of currency payments will be successful.

Alternatively, user A, i.e. the seller may offer to buy the amount of first currency, i.e. Ethereum for the second currency, i.e a fiat currency, and a listing will also be generated by the transaction processor 4 in a similar way as described above.

With reference to the examples in FIGS. 2 and 3, user A 26 sees the listing on the user interface representing the offer by user B 28 and indicates interest in the offer by selecting it 108. The transaction processor 4 then updates the listing to indicate the interest shown by user A and informs user B 110. B is advised of the interest in the offer 112.

If the first or second currency is a fiat currency, then the transaction processor 4 is configured to provide information to the payee relating to a secure location 22 associated with the transaction processor to the payer of the fiat currency. The secure location information can be bank account information, where the bank account is owned or otherwise controlled by the transaction processor 4 such that the transaction processor 4 can monitor for all payments therein. The step of monitoring the secure location 22 can include constant monitoring or periodic checking the bank account at spaced apart intervals, for example every five minutes or every half hour, until it has been verified that the correct amount has been received in the secure location 22. The step of monitoring the bank account 22 is an automated process which commences once the bank account information has been sent to the payer of the fiat currency payment and only concludes when it is verified that the payment has been received. Alternatively, the step of monitoring can be in the form of a manual or one-off check, as may be conducted by administration.

The step of monitoring can include searching for a unique identifier which has been provided to the payer so that they can include it in the deposit reference field when they make a deposit. In an example, the unique identifier can be in the form of a unique code for example, a set of alphanumeric characters.

Storing the fiat currency F in the secure location 22 avoids the storage of cryptocurrencies in a location which makes it susceptible to hacking and internal fraud. Further, if the fiat currency is tampered with, it is easier to track the payments to and from the secure location 22, where it is constantly monitored by the transaction processor 4, and further the fiat currency are protected by the normal protective measures that are in place for financial institutions such as banks.

In the examples illustrated in FIGS. 2 and 3, user A has indicated an interest in providing a second currency in the form of a fiat currency F in return for a first amount of cryptocurrency E. Thus the transaction processor 4 provides bank account information for receiving the fiat currency payment F by user A where the bank account 22 is controlled by the transaction processor 4 114. Advantageously, the bank account 22 is a secure location which is less susceptible to hacking or internal fraud and which can be easily and constantly monitored for payment of fiat currency by the transaction processor 4.

If the first or second currency is a cryptocurrency or token thereof, then the receiver of the cryptocurrency must provide address information so that the ownership of cryptocurrency can be transferred from the provider to the receiver. This cryptocurrency address information may a digital wallet address or a public address key or other address information which may be particular to a type of cryptocurrency. The transaction processor 4 is configured to facilitate transfer of this cryptocurrency information from the receiver to the provider. The provider of the cryptocurrency can then directly transfer ownership of the cryptocurrency to the receiver, also known as a ‘peer to peer’ transaction and the transfer of which is recorded via the blockchain of that particular cryptocurrency, which is typically a public audit chain.

As the transaction is recorded publicly, the transaction processor 4 monitors the relevant audit chain 24 such as a block chain to ensure that the transfer has been completed correctly, including that the correct currency amount has been received by the receiver, in these examples illustrated in FIGS. 2 and 3, user A. The step of monitoring the audit chain 24 can include constant monitoring or periodic checking the audit chain 24 to see if the ownership of a correct amount of blocks in the audit chain 24 has been transferred to the correct owner, which can be actioned at spaced apart intervals, for example every five minutes or every half hour, until the correct ownership has been confirmed. The step of monitoring the audit chain 24 can be monitored directly by the transaction processor 4 or via a third party. The step of monitoring the audit chain 24 is an automated process which commences once the address information, exemplified as a public address key or wallet address, has been sent to the payer of the cryptocurrency payment and only concludes when it is verified that said payment has been received. Alternatively, the step of monitoring can be in the form of periodic checking or manual or one-off check, as may be conducted by administration.

In an alternative to monitoring the audit chain 24 as discussed above, the transaction processor 4 can receive transaction information from user B 28. For example, the transaction information from user B 28 can be in the form of a the transaction confirmation reference, for example a transaction hash, to a transaction that has been recorded on the audit chain 24. In a preferred embodiment, the transaction processor 4 can use the transaction confirmation audit chain 24 to confirm the details of the transaction that user B has claimed to have completed, and use it to verify accordingly.

With reference to FIG. 2, after user B has been advised of the interest in their offer, the transaction processor 4 then requests address information from user A, and user B if this was not provided previously 116. Once user A has provided this address information 118, the transaction processor then facilitates transfer of that address information to user B 122, which is received by user B 124. User A's address information will allow user B to transfer ownership of the cryptocurrency to user A 123.

In this embodiment, user B can provide their address information at the commencement of the process at step 107. However in an alternative embodiment user B can provide their address information once interest by user A in the listing has been confirmed at step 123. Advantageously, user B does not have to transfer their cryptocurrency into their public wallet until said interest has been verified. In this alternative embodiment, the transaction processor 4 will then check the contents of the B's wallet at this stage to ensure that the cryptocurrency offered is present.

The transaction processor 4 can monitor the bank account 22 to watch for the fiat currency F payment from user A 134. At some point after receiving the secure location information, user A then deposits fiat currency F which is received into the bank account 136, 138. Preferably, the step of monitoring can include constant monitoring or periodic checking of the bank account 22. Alternatively, the step of monitoring can be in the form of a manual or one-off check, as may be conducted by administration.

The transaction processor 4 can also monitors the block chain 24 to watch for the transfer of the ownership of cryptocurrency E from user B to user A 126, once the transaction processor 4 has facilitated the transfer of user A's address to user B at step 122. User B, using user A's wallet address provided by the transaction processor 4, assigns ownership of the cryptocurrency E to user A 128 so that user A now owns cryptocurrency E 132. The transfer of ownership of the cryptocurrency E is recorded publicly on the cryptocurrency audit chain 130. Preferably, the step of monitoring can include constant monitoring or periodic checking of the block chain 24. Alternatively, the step of monitoring can be in the form of a manual or one-off check, as may be conducted by administration.

As illustrated in FIG. 3, the transaction processor 4 can check B's wallet to ensure that the cryptocurrency at step 125 is available after the receipt of fiat currency F has been confirmed. However, alternatively, the transaction processor 4 can check B's wallet for sufficient cryptocurrency at any time after the transaction processor 4 has received B's wallet address.

Preferably, as illustrated in FIG. 3, the transaction processor 4 can send user A's wallet address 122 to user B after it has been confirmed that the fiat currency F has been received in the secure location 22. Thus, the transaction processor 4 coordinates the at least one transaction such that the fiat currency payment F is transferred to the secure location 22 before the transfer of any cryptocurrency. If the cryptocurrency payment is not transferred then the fiat currency payment F can be returned to user A thereby advantageously reducing risk to the users of fraudulent behaviour.

Thus advantageously the transaction processor 4 verifies that the currency transfers from user A to the secure location, and from user B to user A, has been completed correctly and safely. At this point, the transaction processor can release the funds in the bank account received from user A to user B 140, 142 so that user B receives the payment of fiat currency F 144. As a final step, the transaction processor 4 advises both parties, user A and user B that the transfers have been completed successfully 146, 148 and the transaction is therefore complete 150.

Prior services for exchanging currencies do not inform the parties of the successful transfer of payments and depends on the goodwill and honest nature of the parties. It will be appreciated that this method provides the advantage that the transfers are verified correctly and both parties are informed which reduces the possibility of fraudulent behaviour on the part of the users. Further, the method may obviate the need for the user to meet in person or to use smart contracts, thereby being a safer and quicker way of conducting transactions involving cryptocurrency. Lastly, the method advantageously may be applicable to any cryptocurrency.

Preferred features of the present invention will now be described with particular reference to the accompanying drawings. However, it is to be understood that the features illustrated in and described with reference to the drawings are not to be construed as limiting on the scope of the invention.

Through-out the specification and claims the word “comprise” and its derivatives is intended to have an inclusive rather than exclusive meaning unless the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the assembly uppermost.

It will be appreciated by those skilled in the art that many modifications and variations may be made to the methods of the invention described herein without departing from the spirit and scope of the invention.

1. A method of facilitating transactions between users using a transaction processor, the transaction processor being configured to facilitate. at least one transaction between a first and second user, the method comprising:
providing a transaction user interface configured to receive currency and identification information from the users;
facilitating transfer of at least one currency payment between the first and second users, wherein the at least one currency payment is based on the currency information;
verifying the at least one currency payment has been transferred correctly; and
indicating to the users that the transfer has been made.

2. The method according to claim 1, wherein facilitating transfer of at least one currency payment comprises receiving the at least one currency payment in a secure storage location associated with the transaction processor.

3. A method of facilitating transactions between users using a transaction processor, the transaction processor being configured to facilitate at least one transaction between a first and second user, the method comprising:
providing a transaction user interface configured to receive currency and identification infer ⁻nation from users; and
facilitating transfer of at least one currency payment between the first and second users, wherein the at least one currency payment is based on the currency information,
wherein facilitating transfer of the at least one currency payment comprises receiving one of the at least one currency payment in a secure storage location associated with the transaction processor.

4. The method according to claim 3, further comprising verifying the at least one currency payment has been transferred correctly and indicating to the users that the transfer has been made.

5. The method according of claim 3, wherein facilitating transfer of the at least one currency payment comprises facilitating a first transfer of a first currency payment from the first user to the second user and facilitating a second transfer of a second currency payment from the second user to the first user.

6. The method according to claim 5, wherein facilitating one of said transfers comprises a transfer of one of said currency payments from the secure storage location when the other of said transfers has been verified.

7. The method according to claim 6, wherein a transfer to the secure storage location comprises a transfer of fiat currency and the secure storage location is a bank account associated with the transaction processor.

8. The method according to claim 7, wherein verifying at least one currency payment has been transferred correctly includes constant monitoring of the bank account to determine when the fiat currency has been deposited.

9. The method according to claim 3, wherein at least one currency payment comprises cryptocurrency.

10. The method according to claim 9, wherein facilitating transfer of the cryptocurrency comprises facilitating transfer of information relating to assignment of an access right of the cryptocurrency from one user to another user.

11. The method according to claim 10, wherein information relating to assignment of an access right of a cryptocurrency includes a public address key.

12. The method according to claim 9, wherein verifying the transfer of cryptocurrency comprises determining the access right is possessed by the second user by monitoring information from an audit chain associated with that cryptocurrency.

13. The method according to claim 9, wherein the step of verifying the transfer of cryptocurrency includes receiving a transaction reference from the second user and using the transaction reference to retrieve information from the audit chain.

14. The method according to claim 8, wherein the step of monitoring information from the audit chain comprises monitoring of the audit chain to determine when the cryptocurrency has been deposited.

15. The method according to claim 8, wherein the monitoring of the audit chain or bank account is one of the following: constant monitoring, periodic monitoring or checking on-demand.

16. The method according to claim 6, wherein the transaction processor is configured to facilitate an exchange of currency between the two users, wherein the first transfer is a fiat currency payment and the second transfer is a cryptocurrency payment in exchange for the fiat currency payment.

17. The method according to claim 15, wherein transaction processor facilitates the first transfer before the second transfer.

18. The method according to claim 3, wherein the step of facilitating transfer of at least one currency payment between users includes generating an offer based on the currency information, the offer being viewable on the transaction user interface and selectable by the second user.

19. The method according to claim 3, wherein receiving identification information from the users includes one or more of the following information:
photo identification including identity documents such as passports, driver's license;
bank account information;
email address information;
telephone number information; and
other contact information; and
wherein the cryptocurrency comprises one or more of the following: Bitcoin, Bitcoin cash, Litecoin, Eos, ethereum or a transferable token based thereon or anything similar that is considered a cryptocurrency.

20. A transaction processor when used to perform the method according to claim 1.
